(19) United States
(12) Patent Application Publication
(10) Pub. No.: US 2014/0365884 A1
(43) Pub. Date: Dec. 11, 2014

(54) VOICE COMMAND RECORDING AND PLAYBACK

(71) Applicants: Feridun Arda Kara, Palo Alto, CA (US); Alan Viverette, Mountain View, CA (US)

(72) Inventors: Feridun Arda Kara, Palo Alto, CA (US); Alan Viverette, Mountain View, CA (US)

(73) Assignee: GOOGLE INC., Mountain View, CA (US)

(21) Appl. No.: 13/456,103

(22) Filed: Apr. 25, 2012

Related U.S. Application Data
(63) Continuation of application No. 13/452,786, filed on Apr. 20, 2012.
(60) Provisional application No. 61/618,652, filed on Mar. 30, 2012.

(51) Int. Cl. G06F 3/01

(52) U.S. Cl. 715/704

(57) ABSTRACT

Methods, systems, and apparatus, including computer programs encoded on a computer storage medium, for playing back user-defined commands is described. In one aspect, a method includes detecting that a user has initiated playback of a user-defined command on a computing device; identifying an entry that is stored in a log associated with the user-defined command, the entry including data representing a user's interactions with a user interface of the computing device and data representing an action to be performed by the computing device; determining an action that is to be performed by the computing device based on the data included in the entry; and performing the action.

### CROSS-REFERENCE TO RELATED APPLICATIONS

This application is a continuation of U.S. patent application Ser. No. 13/452,786, filed Apr. 20, 2012, titled “VOICE COMMAND RECORDING AND PLAYBACK,” which claims the benefit of U.S. Provisional Application No. 61/618,652, filed Mar. 30, 2012, the disclosures of which are incorporated herein by reference in their entirety.

### BACKGROUND

This specification relates to the recording and playback of voice commands.

A user of a computing device may interact with the device by, for example, using a graphical user interface or speaking a voice command.

### SUMMARY

Voice-enabled computing devices may permit users to define a voice command. When a user defines a voice command, the device may record a set of raw user interface interactions, e.g., mouse inputs and keyboard keystrokes, as input by the user. When the user later invokes the user-defined voice command, the device may replay the set of raw user interface interactions as previously performed by the user. If the application or operating system state has changed, or if the graphical user interface is altered or is different from the graphical user interface in which the user performed the actions to define the voice command, replaying the set of raw user interface interactions exactly as performed by the user may not perform the same functionality desired by the user.

In general, one innovative aspect of the subject matter described in this specification may be embodied in methods for recording user-defined commands. During recording of the user-defined command, the device records raw data representing the user's interactions with the user interface. If the user's intent can be inferred from the raw data, the device generates intent data that can be played back in addition to, or as an alternative to, the raw data. The intent data represents the user's intent associated with the raw data. The intent data can be derived from any suitable data that is received, generated, or stored on the device, such as raw data, system state data, message data, contextual data, or stored data.

In general, another innovative aspect of the subject matter described in this specification may be embodied in methods for playing back recorded user-defined commands. During playback of a recorded user-defined command, the device can play back the raw data that was recorded and/or the intent data that was generated by the device during the recording of the user-defined command. If the device was not able to infer the user's intent from the raw data during the recording of the user-defined command, the device plays back the raw data representing the user's interactions with the user interface. If the device was able to infer the user's intent from the raw data during the recording of the user-defined command, the device plays back the intent data representing the user's intent.

In further detail, the methods for recording user-defined commands include detecting a user's interactions with a user interface of a computing device; determining an action that is to be performed by the computing device based on the user's interactions with the user interface; and storing data representing the user's interactions and data representing the action to be performed by the computing device as an entry in a log associated with a user-defined command. The methods for playing back user-defined commands include detecting that a user has initiated playback of a user-defined command on a computing device; identifying an entry that is stored in a log associated with the user-defined command, the entry including data representing a user's interactions with a user interface of the computing device and data representing an action to be performed by the computing device; determining an action that is to be performed by the computing device based on the data included in the entry; and performing the action.

Other embodiments of these aspects include corresponding systems, apparatus, and computer programs, configured to perform the actions of the methods, encoded on computer storage devices.

These and other embodiments for recording user-defined commands may each optionally include one or more of the following features. In various examples, the action includes invoking an application function; the action includes performing a system operation; the action includes changing a state of the user interface; the method further includes determining a state of the user interface, determining the action based on the state of the user interface, and storing data representing the state of the user interface as an entry in the log associated with the user-defined command; the method further includes extracting contextual information from the user interface, determining the action based on the contextual information, and storing data representing the contextual information as an entry in the log associated with the user-defined command; and determining the action based on the user's interactions with the user interface includes accessing a table that includes a mapping of the user's interactions to the action and determining the action based on the mapping.

These and other embodiments for playing back user-defined commands may each optionally include one or more of the following features. In various examples, identifying an entry that is stored in the log includes determining a current system state of the computing device and identifying the entry that corresponds to the current system state; the entry includes data representing contextual information from the user interface and the method further includes processing the data representing the contextual information to identify an item in the user interface screen and performing the action on the identified item; the action includes invoking an application function; the action includes performing a system operation; the action includes changing a system state of the computing device; and the action includes converting the text to speech and outputting the speech to a speaker.

Particular embodiments of the subject matter described in this specification may be implemented to realize one or more of the following advantages. The voice interface may allow a user to create a voice command for invoking and controlling a functionality that does not have an independent voice interface. A user-defined command may be played back by invoking the underlying functionality instead of replicating all of the user's interactions with the device. If the user interface is altered or is different from the user interface in which the user performed the actions to define the command, the command can be played back from the intent data representing the user's intent.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1 and 2 are conceptual diagrams of exemplary frameworks for recording user-defined voice commands.

FIG. 3 is a flowchart of an example process for recording user-defined voice commands.

FIG. 4 is a diagram of an exemplary system for recording and playing back user-defined voice commands.

FIGS. 5-8 are conceptual diagrams of an exemplary framework for playing back a user-defined voice command.

FIG. 9 is a flowchart of an example process for playing back user-defined voice commands.

### DETAILED DESCRIPTION

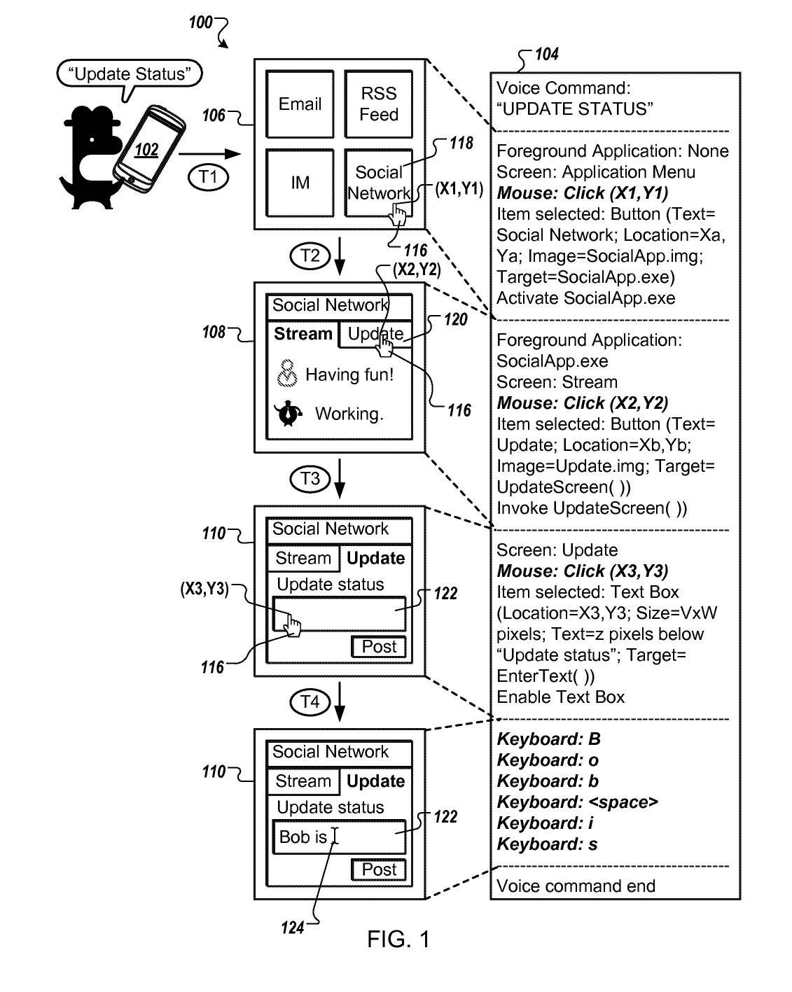

FIG. 1 is a conceptual diagram of an exemplary framework 100 for recording user-defined voice commands. In particular, the framework 100 includes a client device 102. The client device 102 may include, for example, a cellular telephone, a personal digital assistant (PDA), a music player, a tablet computer, an e-book reader, or other processing device. A user may invoke certain functionality of the client device 102 by using input controls, such as buttons, a number pad, a touch screen, a miniature keyboard, a voice input device, or a stylus.

To initiate a recording for a voice command, the user may press a button designated for recording of a voice command. For example, the user can tap a record button displayed on the user interface of a voice command application. As another example, the user can press and hold a physical button of the client device 102 that has been preprogrammed to initiate a recording of a voice command until the client device 102 indicates that recording of the voice command has begun. Alternatively, the user can use voice input to initiate a recording of a voice command. For example, the user can press a microphone button on the client device 102 and speak the voice command for initiating a recording of a user-defined voice command.

When creating a voice command, the user may enter a name for the voice command. The user may enter a name for the voice command by, for example, speaking the name of the voice command after initiating the recording of the voice command. As another example, the user may enter a name for the voice command by entering text into a text box of a user interface screen of a voice command application before initiating the recording of the voice command. After the user enters the name for the voice command, the client device 102 may determine whether the name entered by the user is available, e.g., the name is not associated with another voice command. If the name is not available, the client device 102 may notify the user and allow the user to enter a different name for the voice command. Once the user enters a valid name, the name is stored in a log 104 associated with the voice command. The name may be stored as text in the log 104. If the user entered the name by speaking the name of the voice command, the name of the voice command may also be stored as an audio file with information that links the audio file to the log 104.

In some implementations, the user may associate the voice command with an action for playing back the voice command as an alternative to speaking the name of the voice command. For example, the user may designate a button, e.g., a physical button on the client device 102 or a virtual button in the user interface of the voice command application, for playing back the voice command, and the user may associate the voice command with a press of the button. The user may associate the voice command with a movement of the client device 102 for playing back the voice command. In general, the user may associate the voice command with any suitable technique that can be used to initiate the playback of the voice command.

During the recording of the voice command, the user may interact with one or more user interface screens. The client device 102 detects the user's interaction with a user interface, and records various types of data in the log 104 while the user is interacting with the interface screens. The data enables the client device 102 to play back the voice command. The device 102 may record raw data (represented by text in italics and bold in the log 104 of FIG. 1) that represents the user's interaction with the interface screens, such as mouse and keyboard sequences, exactly as performed by the user. The device 102 may record intent data that represents the user's intent associated with the raw data. For example, intent data can include actions performed by the client device 102, such as firing events in response to a mouse click. Intent data may indicate the services or applications that are invoked during the recording of the voice command. The device 102 may record system state data that describes the state of the client device 102 or the state of an application with which the voice command is associated. For example, system state data can include information about the user interface that is being displayed while a user performs an action. The device 102 may record contextual information from a user interface. For example, contextual information can include text, location, or image of a button that the user clicked on.

When the user has finished recording the voice command, the user stops the recording. The user may stop the recording by, for example, pressing a physical or virtual button designated for stopping the recording of a voice command. Alternatively, the user may stop the recording by speaking the voice command for stopping the recording of a voice command. Once the user stops the recording of the voice command, the client device 102 may store an indication that the voice command has ended in the log 104.

FIG. 1 shows examples of the user's interactions with user interface screens 106, 108, 110 at times T1 to T4 during the recording of a user-defined voice command for updating the user's status in a social networking application. During the recording of the voice command, the log 104 is updated with data associated with the voice command and the user's interactions with the user interface screens 106, 108, 110. As illustrated in FIG. 1, the log 104 includes the name of the voice command, e.g., “UPDATE STATUS.” The user may speak “update status” into a microphone of the client device 102, to indicate the name of the voice command that the user is recording. Alternatively, the user may indicate the name of the voice command by entering the text “UPDATE STATUS” using a keyboard of the client device 102. The client device 102 may then store the name of the voice command as the first entry in the log 104.

At time T1 during the recording, no foreground application is running on the client device 102, and the device 102 is displaying the application menu screen 106. To indicate that no foreground application is running and that the user is interacting with the application menu screen 106, the client device 102 may store system state data representing the state of the device 102, such as “Foreground Application: None” and “Screen: Application Menu” in the log 104.

While the application menu screen 106 is displayed, the user moves the mouse cursor 116 to position (X1, Y1) and clicks a mouse button to launch a social networking application. The client device 102 may store raw data related to the mouse cursor movement and selection in the log 104 by updating the log 104 with information such as “Mouse: Click (X1, Y1).” Based on the location of the cursor 116 when the user clicked the mouse, the device 102 detects that the user has selected a button 118. The device 102 can extract contextual data associated with the button 118. The contextual data can include the text associated with the button 118, the location of the button 118, the image of the icon associated with the button 118, the application targeted by the button 118, and other information that is associated with the button 118. The client device 102 may store the contextual data associated with the button 118, such as “Item Selected: Button (Text=Social Network; Location=Xa, Ya; Image=SocialApp.img; Target=SocialApp.exe).”

In response to the user clicking the mouse while the mouse cursor 116 is at position (X1, Y1) over the button 118, the client device 102 launches the social networking application associated with the button 118. Based on the state of the device 102, the user's interactions with the user interface, and the launching of an application, the client device 102 can infer that the user's intent is to open the application when performing the mouse movements and selection. For example, the client device 102 infers that the user intended to open the social networking application because the device 102 is displaying the application menu screen, the user has selected a button at location (X1, Y1), and the device 102 launched the social networking application in response to the user's selection. The device 102 stores intent data in the log 104 representing the user's intent associated with the raw data. For example, the client device 102 may update the log 104 with intent data that indicates the social networking application was launched during recording of the voice command by including an entry “Activate SocialApp.exe” in the log 104.

At time T2, the client device 102 has launched the social networking application. The social networking application is running in the foreground, and the client device is displaying the Stream screen 108 of the application. The client device 102 updates the log 104 with system state data describing this information, such as “Foreground Application: SocialApp.exe” and “Screen: Stream.”

While the Stream screen 108 is displayed, the user moves the cursor 116 to position (X2, Y2) and clicks the mouse button to change the user interface screen of the social networking application. The client device 102 may store raw data related to the mouse cursor movement and selection in the log 104 by updating the log with information such as “Mouse: Click (X2, Y2).” Based on the location of the cursor 116 when the user clicked the mouse, the device 102 detects that the user has selected a button 120. The device 102 can extract contextual data associated with the button 120. The contextual data can include information that describes the button 120, such as text associated with button 120, location of the button 120, image of the icon associated with button 120, functionality associated with the button 120, and other information that is associated with the button 120. The client device 102 may store the contextual data associated the button 120, such as “Item Selected: Button (Text=Update; Location=Xb, Yb; Image=Update.img; Target=UpdateScreen( )).”

In response to the user clicking the mouse while the mouse cursor 116 is positioned at (X2, Y2) over the button 120, the client device 102 changes the user interface screen from the Stream screen 108 to the Update screen 110 of the social networking application. Based on the state of the device 102, the user's interactions with the user interface, and the change from one interface screen to another interface screen, the device 102 can infer that the user's intent is to cause the device 102 to display the second interface screen. For example, the client device 102 infers that the user intended to cause the device 102 to display the Update screen 110 of the social networking application because the device 102 is running the social networking application, the device 102 is displaying the Stream screen 108 of the application, the user has selected a button at location (X2, Y2), and the device 102 changed the interface screen to the Update screen 110 in response to the user's selection. The device 102 stores intent data in the log 104 representing the user's intent associated with the raw data. For example, the client device 102 updates the log 104 with intent data that indicates the device invoked the Update screen 110 during the recording of the voice command by including an entry “Invoke UpdateScreen( ))” in the log 104.

At time T3, the client device 102 has changed the user interface screen that is displayed on the client device 102 from the Stream screen 108 to the Update screen 110. The client device 102 updates the log with system state data indicating that the screen being displayed is the Update screen 110 by, for example, including an entry “Screen: Update.”

While the Update screen 110 is displayed, the user moves the cursor 116 to position (X3, Y3) and clicks the mouse button to enable text entry in a text box 122. The client device 102 may store raw data related to the mouse cursor movement and selection in the log 104 by updating the log with information such as “Mouse: Click (X3, Y3).” Based on the location of the cursor 116 when the user clicked the mouse, the device 102 detects that the user has enabled the text box 122. The device 102 can extract contextual data associated with the text box 122. The contextual data can include information that describes the text box 122, such as text near the text box 122, location of the text box 122, size of the text box 122, functionality associated with the text box 122, and other information associated with the text box 122. The client device 102 may store the contextual data associated with the text box 122, such as “Item Selected: Text Box (Location=X3,Y3; Size=V×W pixels; Text=Z pixels below ‘Update Status’; Target=EnterText( )).”

In response to the user clicking the mouse while the mouse cursor 116 is positioned at (X3, Y3) over the text box 122, the client device 102 enables the text box 122 and the mouse cursor 116 changes to a text cursor 124. Based on the state of the device 102, the user's interactions with the user interface, and the enabling of a text box, the device 102 can infer that the user's intent is to enter text into the text box 122. For example, the client device 102 infers that the user intended to enter text into the text box 122 because the device 102 is running the social networking application, the device 102 is displaying the Update screen 110 of the application, the user has selected a text box 122 at location (X3, Y3), and the device 102 has enabled text entry in the text box 122 in response to the user's selection. The device stores intent data in the log 104 representing the user's intent associated with the raw data. For example, the client device 102 updates the log 104 with intent data that indicates the text box 122 has been enabled by the user during the recording of the voice command by including an entry “Enable Text Box.”

At time T4, the user enters the text string “Bob is” into the text box 122 using a keyboard of the client device 102. The client device 102 may store raw data related to the keystrokes such as “Keyboard: B,” “Keyboard: o,” “Keyboard: b,” “Keyboard: <space>,” “Keyboard: i,” “Keyboard: s.” Because the keystrokes do not invoke any underlying functionality of the device, e.g., does not change an application or operating system state, and the client device 102 does not infer an intent associated with the raw data.

After entering the text into the text box 122, the user stops the recording of the voice command. The client device 102 stores an indication in the log 104 that the recording of the voice command has been stopped by the user. For example, the client device 102 may include an entry “Voice Command End” in the log 104 to indicate that the recording has been stopped.

In some instances, as described above when the user entered the text string “Bob is” into the text box 122, the client device 102 does not infer an intent associated with the raw data because the user's interaction with the device 102 does not invoke an underlying functionality of the device 102. In other instances, the client device 102 may infer an intent associated with the raw data even though the user's interaction with the device 102 does not invoke an underlying functionality of the device 102. To infer an intent associated with raw data that does not invoke an underlying functionality, the device 102 may access a lookup table that associates raw data parameters with an intent.

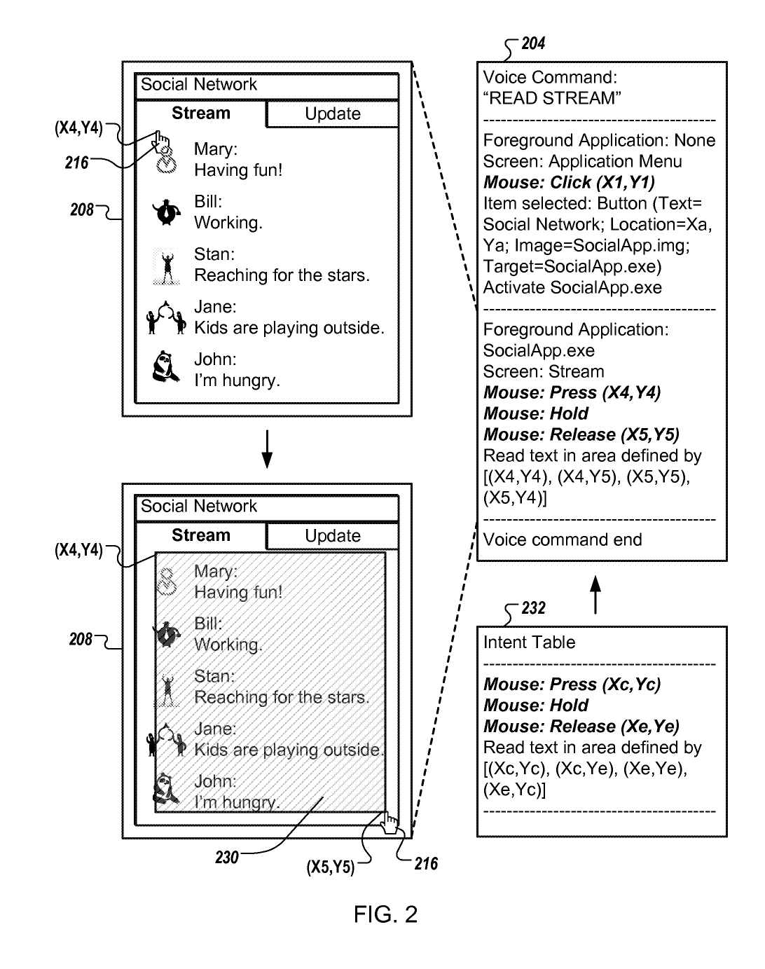

FIG. 2 shows an example of a user's interactions with the device 102 that does not invoke an underlying functionality of the device 102, e.g., does not invoke a function or feature of the social network application or the operating system. The device 102 may nevertheless infer an intent associated with the user's interactions. In FIG. 2, the user is recording a voice command for reading a stream of updates in a social networking application. The user may interact with the device 102 in a similar manner as shown in FIG. 1 to get to the stream screen 208 of the social networking application. While the stream screen 208 of the social networking application is displayed, the user moves the cursor 216 to position (X4, Y4) and presses the mouse button. While holding the mouse button, the user moves the cursor 216 to position (X5, Y5) and releases the mouse button. By pressing and holding the mouse button while moving the mouse from position (X4, Y4) to position (X5, Y5), the user has created a selection box 230 over the stream of updates. The device 102 may store the raw data associated with the user's mouse movements and selection in the log 204. For example, the device 102 may store raw data entries “Mouse: Press (X4,Y4),” “Mouse: Hold,” and “Mouse: Release (X5,Y5).”

The creation of the selection box 230 does not invoke a function or feature of the social network application or the operating system. To determine the user's intent, the device 102 may access a lookup table, such as Intent Table 232, that includes an entry describing the intent associated with the creation of a selection box. The intent may be predefined by the user, by the voice command application, or by any other module or application of the device 102. The raw data is mapped to the entry in the intent table 232 to determine the intent. Based on the Intent Table 232, the device 102 determines that the user's intent associated with the raw data is to cause the device to read the text in the area defined by the selection box 230, e.g., the text in the area defined by [(X4, Y4), (X4, Y5) (X5, Y5), (X5, Y4)]. The device 102 may store the intent as intent data in the log 204. For example the device 102 may store an entry “Read text in area defined by [(X4, Y4), (X4, Y5) (X5, Y5), (X5, Y4)].”

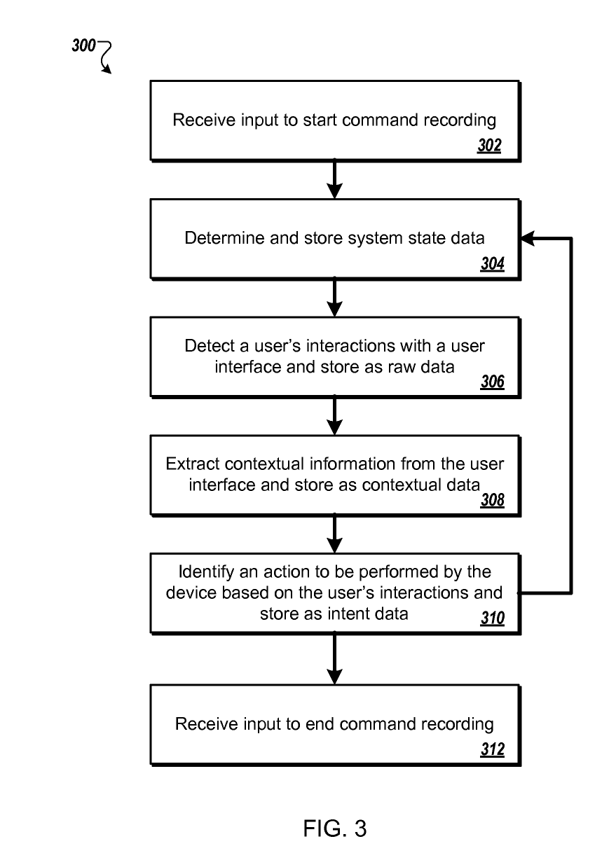

FIG. 3 is a flowchart of an example process 300 for recording user-defined commands. Briefly, the process 300 includes detecting a user's interactions with a user interface, determining an action that is to be performed by the client device based on the user's interactions with the user interface, and storing data representing the user's interactions and data representing the action to be performed by the client device.

In more detail, the process 300 begins when an input to start a user-defined command recording is received (302). System state data describing the state of a device is determined and stored as one or more entries in a log associated with the voice command (304). System state data can include, for example, the application that is running in the foreground, the user interface screen that is being displayed, or other similar information.

A user's interactions with a user interface are detected, and raw data describing the user's interactions is stored in the log (306). For example, the device may detect a mouse movement, a mouse click, a keystroke, a tap on a touchscreen, a press of a physical button, or other similar interactions with the user interface. The raw data that describes the user's interactions may include, for example, raw coordinates indicating movement of the mouse, raw coordinates indicating a location of a mouse click or tap on a touchscreen, number or timing of mouse clicks, actual keys pressed on a keyboard, or other similar information.

Contextual information associated with the user's interactions is extracted from the user interface, and contextual data describing the contextual information is stored in the log (308). Contextual information may include text, images, location, and other information associated with the selected item. For example, if a user selects a button, the contextual data associated with the button may include the text overlaying the button, the text near the button, the color of the button, the image of the button, the location of the button, the dimensions of the button, the functionality invoked by the button, and other similar information.

An action to be performed by the client device is identified based on the user's interactions with the client device, and intent data describing the action is stored in the log (310). The intent data represents the user's intent associated with the raw data. For example, intent data can include actions performed by the client device 102, such as firing events in response to a mouse click. Intent data may indicate the system operations, services, or applications that are invoked during the recording of the voice command.

An action may be identified based on evaluation of the system state data, the raw data, and/or the contextual data. An action may be identified by accessing a lookup table that includes an entry describing the action associated with the raw data. The action may be predefined by the user, by the voice command application, or by any other module or application of the device. The raw data is mapped to the entry in the lookup table to identify the action.

If an input to end the user-defined command recording has not been received, the process 300 repeats from 304. The process 300 ends when an input to end the user-defined command recording is received (412).

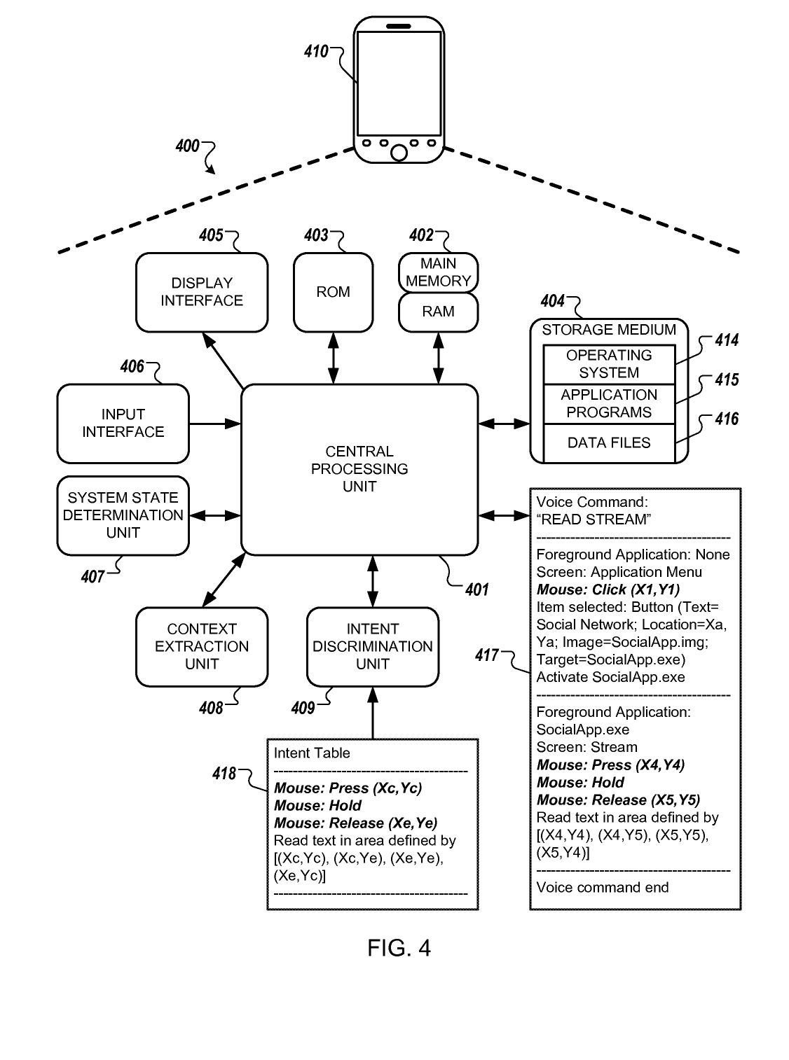

FIG. 4 is a block diagram illustrating an exemplary internal architecture 400 of a client device 410 for recording and playing back voice commands. The architecture 400 includes a central processing unit (CPU) 401, a random access memory (RAM) 402, a read-only memory (ROM) 403, a storage medium 404, a display interface 405, and an input interface 406. The CPU 401 processes the computer instructions that comprise an operating system or an application. The RAM 402 includes a volatile memory device that stores computer instructions and data for processing by the CPU 401. The ROM 403 includes a non-volatile memory device that stores invariant low-level systems code or data for basic system functions such as basic input and output (I/O), startup, or reception of keystrokes from a keyboard. The storage medium 404 or other suitable type of memory (e.g., such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives) stores files that comprise an operating system 414, application programs 415 (including, for example, a voice command application, a social networking application, and/or other applications, as necessary) and data files 416 (including, for example, a voice command log 417, an intent table 418, and/or other files, as necessary). The display interface 405 provides a communication interface and processing functions for rendering video, graphics, images, and texts in a user interface. The input interface 406 provides a communication interface to a stylus, keyboard, and/or other input device(s) attached to the client device 410.

A computer program product is tangibly embodied in the storage medium 404, a machine-readable storage medium. The computer program product includes instructions that, when read by a data processing apparatus, operate to cause the data processing apparatus to perform the instructions for recording and playing back voice commands.

The architecture 400 may include a system state determination unit 407, a context extraction unit 408, and an intent discrimination unit 409 to provide the voice command recording and playback functionalities of the device 410. The system state determination unit 407 determines the state of the device 410 when the user begins recording or playing back a voice command and when the device 410 changes from one state to another. During recording of a voice command, the state of the device is stored in the log 417 as system state data. System state data can include information that indicates the application running in the foreground, the user interface screen being displayed, and other similar information. Examples of system state data in log 417 include the entries “Foreground Application: None,” “Screen: Application Menu,” Foreground Application: SocialApp.exe,” and “Screen: Stream.” During playback of a voice command, the system state determination unit 407 may determine the current state of the device 410 and compare the current state with system state data in the log 417 to identify the actions and/or events that are to be played back.

During recording of a voice command, the context extraction unit 408 determines the contextual data associated with items in the display interface 405 that the user selects using the input interface 406. The context of the selected item is stored in log 417 as contextual data. Contextual data may include text, images, location, and other information associated with the selected item. For example, if a user selects a button, the contextual data associated with the button may include the text overlaying the button, the text near the button, the color of the button, the image of the button, the location of the button, the dimensions of the button, the functionality invoked by the button, and other similar information. An example of contextual data in log 417 includes the entry “Item selected: Button (Text=Social Network; Location=Xa,Ya; Image=SocialApp.img; Target=SocialApp.exe).” During playback of a voice command, the context extraction unit 408 may identify contextual data in the log 417 that is associated with the current state of the device to identify the actions and/or events that are to be played back.

During recording of a voice command, the intent discrimination unit 409 determines the intent associated with the user's interactions with the device 410. In some instances, the intent may be inferred from the state of the device, the user's interactions with the device, the contextual data associated with selected items, and/or the functionality invoked as a result of the user's actions. In other instances, the intent may be inferred using the intent table 418 that maps the user's interactions with the device to a predefined intent. The intent is stored in log 417 as intent data. Examples of intent data in log 417 include the entries “Activate SocialApp.exe,” and “Read text in area defined by [(X4, Y4), (X4, Y5) (X5, Y5), (X5, Y4)].”

During playback of a voice command, the intent discrimination unit 409 may identify the intent data in the log 417 that is associated with the current state of the device to identify the actions and/or events that are to be played back. If the log 417 does not include contextual data or intent data that is associated with the current state of the device from which a user's intent can be inferred and the intent discrimination unit 409 cannot derive the user's intent associated with the raw data, the intent discrimination unit 409 may play back the actions described by the raw data.

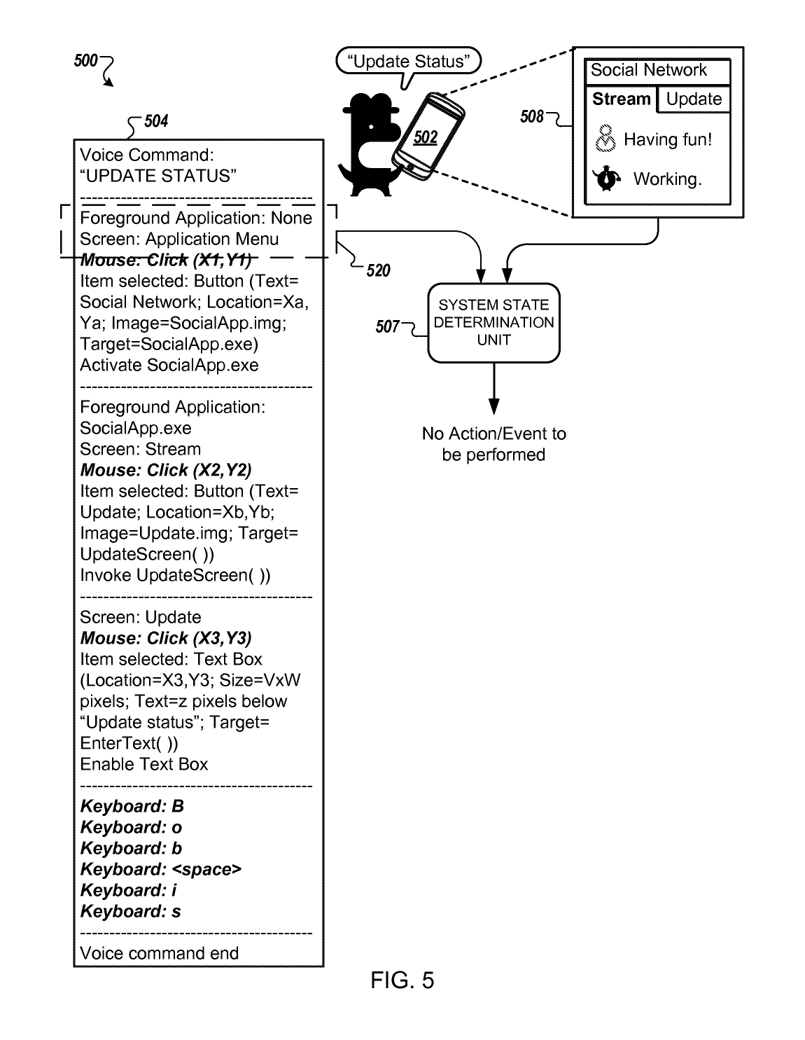

FIGS. 5-7 are conceptual diagrams of an exemplary framework 500 for playing back a user-defined voice command, for example, the user-defined voice command recorded on a client device 502 for the voice command “UPDATE STATUS,” as described above with reference to FIG. 1. To play back a voice command, the user may press a button designated for playing back voice commands and/or speak the name of the voice command. For example, the user can press a microphone button on the client device 502 and speak the phrase “update status” to play back the voice command “UPDATE STATUS.” As another example, the user can press a button on a user interface of a voice command application that is designated for playing back the voice command. As yet another example, the user can move the client device 502 in pattern that is designated for playing back the voice command. In general, play back of a voice command can be associated with any suitable technique that can be used to initiate the playback of a voice command.

The client device 502 receives an audio signal with an utterance “update status.” The client device 502 processes the audio signal to translate the spoken utterance into a voice command. The client device 502 may use suitable voice recognition models, such as speech models, acoustic models, noise models, and/or other models, to translate the spoken utterance and enhance the intelligibility of the spoken utterance. To translate the spoken utterance into a voice command, the client device 502 may compare the spoken utterance with spoken names of voice commands contained in audio files that are linked to log files of voice commands. In some implementations, the client device 502 may convert the speech in the audio signal to text and search for the text in log files of voice commands.

In FIG. 5, the client device 502 identifies the log file 504 associated with the voice command for the spoken utterance “update status.” After the client device 502 identifies the log file 504, the system state determination unit 507 determines the current system state. The system state determination unit 507 compares the current system state with system state data that are recorded in the log 504.

For example, the system state determination unit 507 determines that a social networking application is running in the foreground and a Stream screen 508 of the social networking application is being displayed on the client device 502. The system state determination unit 507 compares the current system state with the system state data entry 520 having the description “Foreground Application: None” and “Screen: Application Menu.” The system state determination unit 507 determines that the system state data entry 520 does not describe the current system state. Based on this determination, the system state determination unit 507 determines that the actions and events associated with the system state data entry 520 do not need to be performed.

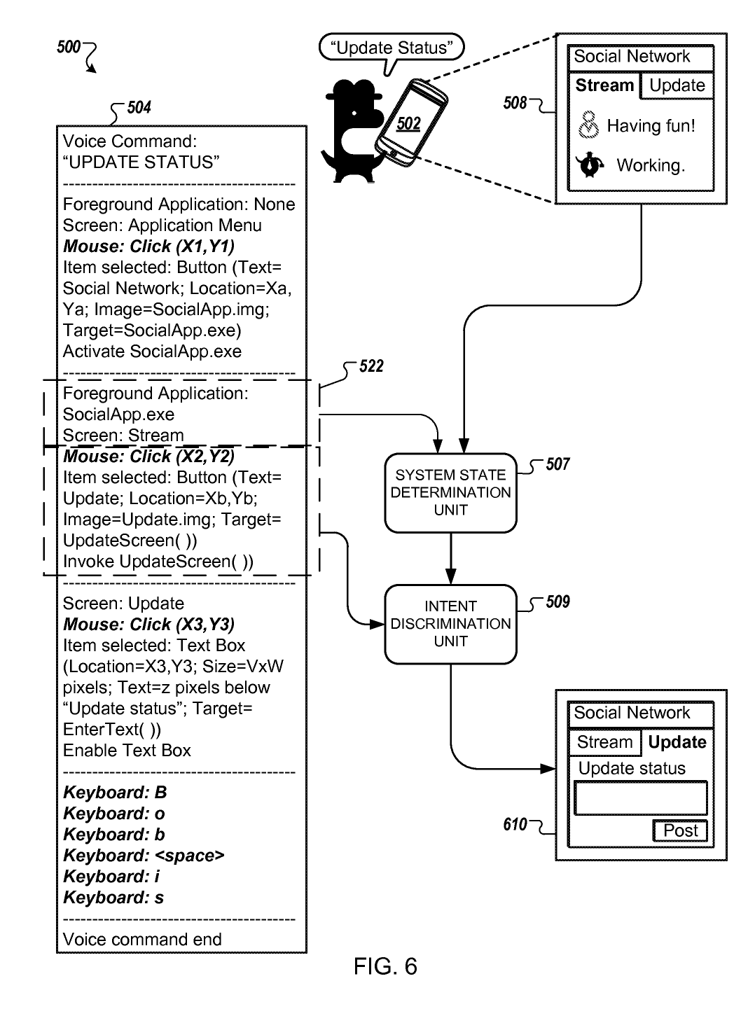

In FIG. 6, the system state determination unit 507 identifies the next system state data entry 522 having the description “Foreground Application: SocialApp.exe” and “Screen: Stream.” The system state determination unit 507 determines that the system state data entry 522 describes the current system state.

When the system state determination unit 507 determines that a system state data entry in the voice command log describes the current system state, the intent discrimination unit 509 identifies the raw data, contextual data, and intent data associated with the system state data. For example, the intent discrimination unit 509 identifies the raw data “Mouse: Click (X2, Y2),” the contextual data “Item selected: Button (Text=Update; Location=Xb,Yb; Image=Update.img; Target=UpdateScreen( )),” and the intent data “Invoke UpdateScreen( ))” as being associated with the system state data because the raw data, contextual data, and intent data describe actions and events that occurred while the device 502 was in the system state described by the system state data during recording of the voice command. The intent discrimination unit 509 determines that the intent data “Invoke UpdateScreen( ))” represents the user's intent associated with the raw data. The intent discrimination unit 509 invokes the underlying functionality described by the intent data “Invoke UpdateScreen( ))” without playing back the raw user interface actions described by the raw data and the contextual data. When the intent discrimination unit 509 plays back the intent data “Invoke UpdateScreen( ),” the user interface screen displayed on the client device 502 changes from the Stream screen 508 to the Update screen 610.

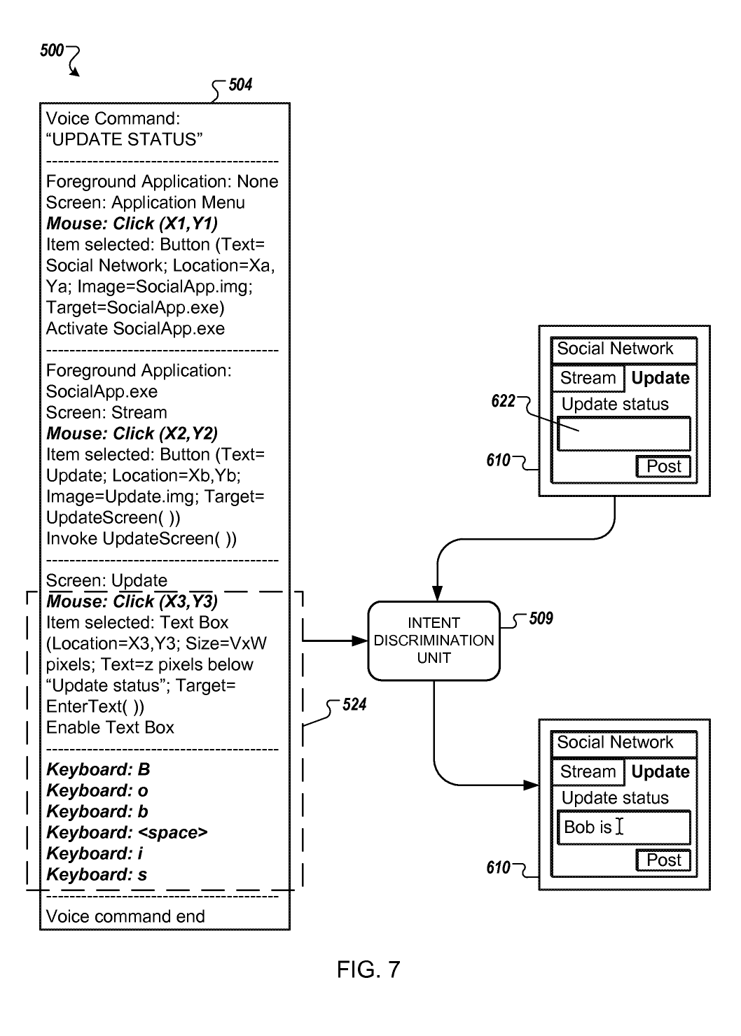

In FIG. 7, while the device 502 is displaying the Update screen 610, the intent discrimination unit 509 identifies the next set 524 of raw data, contextual data, and intent data associated with the Update screen 610. For example, the intent discrimination unit 509 identifies the raw data “Mouse: Click (X3,Y3),” the contextual data “Item selected: Text Box (Location=X3,Y3; Size=V×W pixels; Text=z pixels below ‘Update Status’; Target=EnterText( ),” and the intent data “Enable Text Box” as being associated with the Update screen 610. The intent discrimination unit 509 determines that the intent data “Enable Text Box” represents the user's intent associated with the raw data, which is to invoke the underlying functionality of the social network application for enabling the text box 622. The intent discrimination unit 509 enables the text box 622 without playing back the raw user interface actions associated with the raw data and the contextual data.

The intent discrimination unit 509 identifies the raw data “Keyboard: B,” “Keyboard: o,” “Keyboard: b,” “Keyboard: <space>,” “Keyboard: i,” and “Keyboard: s” as also being associated with the Update screen 610. The intent discrimination unit 509 does not identify any contextual data or intent data associated with this raw data. When no contextual data or intent data is associated with raw data and the intent discrimination unit 509 cannot derive the user's intent associated with the raw data, the intent discrimination unit 509 plays back the raw user interface actions described by the raw data. For example, the intent discrimination unit 509 plays back the raw user interface actions described by the raw data “Keyboard: B,” “Keyboard: o,” “Keyboard: b,” “Keyboard: <space>,” “Keyboard: i,” and “Keyboard: s.” Because the text box 622 has been enabled, playing back the raw user interface actions enters the text “Bob is” into the text box 622 of the Update screen 610.

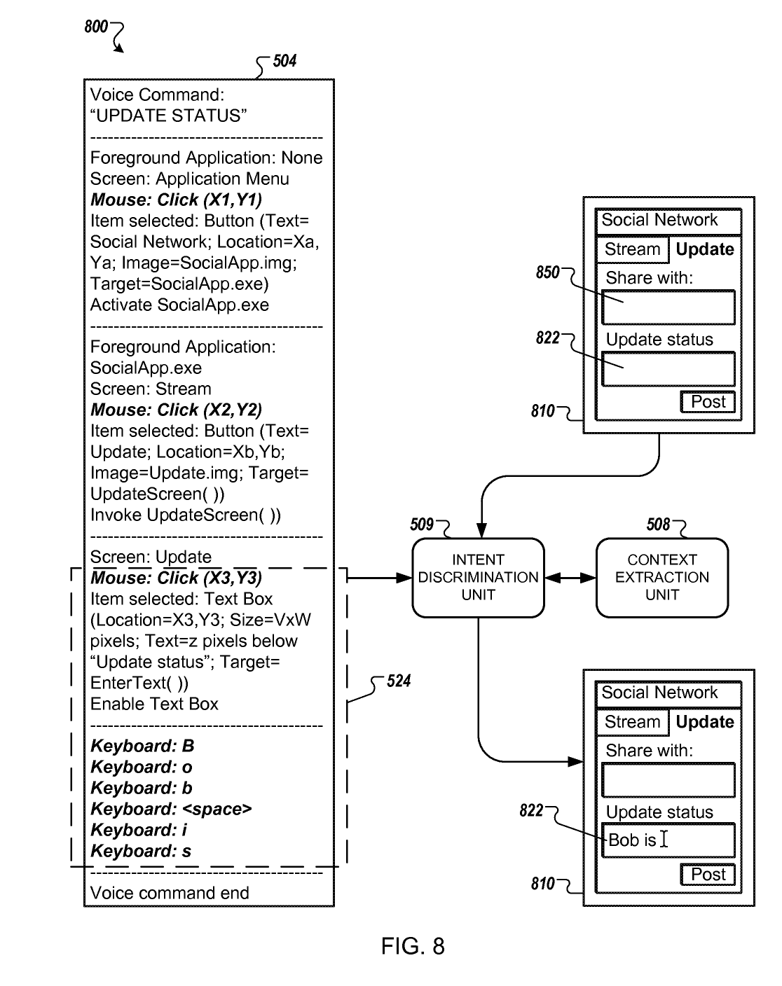

FIG. 8 is a conceptual diagram of an exemplary framework 800 for playing back a user-defined voice command where a user interface screen that was manipulated by a user's actions during recording of the voice command has been modified since the recording of the voice command. For example, the Update screen 110 in FIG. 1 has been modified since the recording of the voice command for “Update Status” to Update screen 810 in FIG. 8 to include an additional text box 850 where the user can optionally choose the people with whom the user wishes to share his status.

In FIG. 8, the intent discrimination unit 509 identifies the set 524 of raw data, contextual data, and intent data. For example, the intent discrimination unit 509 identifies the raw data “Mouse: Click (X3,Y3),” the contextual data “Item selected: Text Box (Location=X3,Y3; Size=V×W pixels; Text=z pixels below ‘Update Status’; Target=EnterText( ),” and the intent data “Enable Text Box” as being associated with the Update screen 810. The intent discrimination unit 509 determines that the intent data “Enable Text Box” represents the user's intent associated with the raw data, which is to invoke the underlying functionality of the social network application for enabling a text box of the Update screen 810. But because the Update screen 810 now includes two text boxes 850, 822, the context extraction unit 508 may be used to determine which text box the user selected during the recording of the voice command. For example, the context extraction unit 508 may process the contextual data “Item selected: Text Box (Location=X3,Y3; Size=V×W pixels; Text=z pixels below ‘Update Status’; Target=EnterText( ))” to determine which text box the user selected.

To process the contextual data, the context extraction unit 508 may apply one or more rules to the contextual data for the item that was selected during recording of the voice command. For example, the context extraction unit 508 may process the attributes of the selected item in an order that is based on a likelihood that the attributes have changed. This may include, for example, processing the contextual data describing text or image associated with the selected item before processing the contextual data describing raw coordinates associated with the selected item. If the context extraction unit 508 identifies an item in the user interface screen with the same text or image as the item selected during recording of the voice command, the context extraction unit 508 may determine that the identified item is the item the user intended to select without processing the contextual data describing the raw coordinates.

In FIG. 8, for example, the context extraction unit 508 may process the contextual data describing the attributes “Text=z pixels below ‘Update status’,” which describes text that is associated with a text box that the user selected during recording of the voice command. The context extraction unit 508 identifies the text box 822 as being z pixels below the text “Update status.” The context extraction unit 508 thus infers that the user intended to select text box 822 during recording of the voice command without processing the other contextual data associated with the selected item. Based on the determination made by the context extraction unit 508, the intent discrimination unit 509 determines that the intent data “Enable Text Box” represents the user's intent to enable text box 822.

In another example, the context extraction unit 508 may process the attributes of the selected item by assigning weights to the different attributes based on a likelihood that the attributes have changed. This may include, for example, assigning a higher weight to contextual data describing text, image, or other similar attribute, and assigning a lower weight to contextual data describing raw coordinates, such as location or size, associated with the selected item.

In FIG. 8, for example, the context extraction unit 508 may assign weights to the attributes in the following order from the highest weighted attributed to the lowest weighted attribute: (4) “Text=z pixels below ‘Update Status’,” (3) “Target=EnterText( ),” (2) “Size=V×W,” and (1) “Location=X3,Y3.” The context extraction unit 508 processes the contextual data describing the attribute “Location=X3,Y3” and determines that the text box 850 has that attribute. The context extraction unit 508 processes the contextual data describing the attribute “Size=V×W pixels” and determines that the text box 850 and the text box 822 both have that attribute. The context extraction unit 508 processes the contextual data describing the attribute “Text=z pixels below ‘Update status’” and determines that text box 822 has that attribute. The context extraction unit 508 processes the contextual data describing the attribute “Target=EnterText( ))” and determines that the text box 850 and the text box 822 both have that attribute. The context extraction unit 508 thus determines that the text box 850 and the text box 822 are both possible items that the user intended to select during recording of the voice command. But because the text box 822 have attributes matching the attributes having the higher weights, e.g., “Text=z pixels below ‘Update Status’,” “Target=EnterText( ),” and “Size=V×W,” the context extraction unit 508 infers that the user intended to select the text box 822 rather than the text box 850. Based on the determination made by the context extraction unit 508, the intent discrimination unit 509 determines that the intent data “Enable Text Box” represents the user's intent to enable text box 822.

The intent discrimination unit 509 identifies the raw data “Keyboard: B,” “Keyboard: o,” “Keyboard: b,” “Keyboard: <space>,” “Keyboard: i,” and “Keyboard: s” as also being associated with the Update screen 810. The intent discrimination unit 509 does not identify any contextual data or intent data associated with this raw data. When no contextual data or intent data is associated with raw data and the intent discrimination unit 509 cannot derive the user's intent associated with the raw data, the intent discrimination unit 509 plays back the raw user interface actions described by the raw data. For example, the intent discrimination unit 509 plays back the raw user interface actions described by the raw data “Keyboard: B,” “Keyboard: o,” “Keyboard: b,” “Keyboard: <space>,” “Keyboard: i,” and “Keyboard: s.” Because the text box 822 has been enabled, playing back the raw user interface actions enters the text “Bob is” into the text box 822 of the Update screen 810.

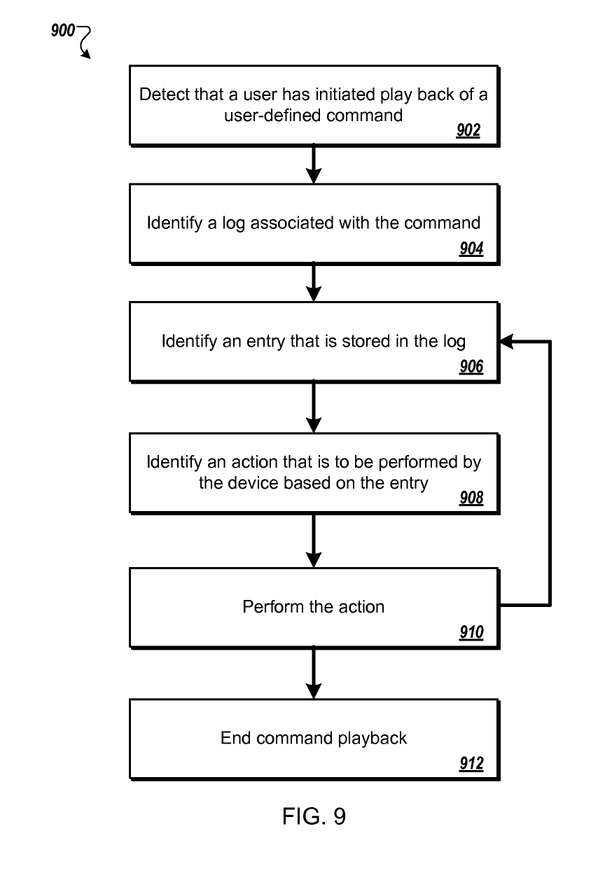

FIG. 9 is a flowchart of an example process 900 for playing back user-defined voice commands. Briefly, the process 900 includes detecting that a user has initiated playback of a user-defined command, identifying an entry in a log associated with the user-defined command, determining an action that is to be performed by a client device based on data included in the entry, and performing the action.

In more detail, the process 900 begins when a client device detects that a user has initiated playback of a user-defined command (902). For example, the client device detects that a user has initiated playback of a user-defined command when the client device detects that the user has spoken a voice command. When an audio signal with a spoken utterance is received, the audio signal is processed to translate the utterance into a voice command.

A log associated with the command is identified (904). To identify a log associated with the command, the utterance may be compared with spoken names of voice commands contained in audio files that are linked to log files of voice commands. The speech in the audio signal may be converted to text, and the names stored in log files of voice commands may be compared to the text to identify a log associated with the spoken voice command.

A log entry of the command log is identified (906). The entry may include system state data, raw data, contextual data, and/or intent data. The entry may be identified by determining a current system state of the client device and identifying an entry that corresponds to the current system state. A current system state may be determined and compared with system state data that are recorded in the log. If a system state data entry does not describe the current system state, the actions and events associated with the system state data entry are not performed. If a system state data entry describes the current system state, the raw data, contextual data, and intent data associated with the system state data entry are processed to determine the actions and events that are to be performed. If a system state data entry that describes the current system state cannot be identified, the current system state may be changed to correspond to the first system state data entry stored in the log, and the command may be played back from the system state described by the first system state data entry.

An action that is to be performed by the client device is identified based on the entry (908). The action can be identified based on system state data, raw data, contextual data, and/or intent data included in the entry. An action may include invoking a system operation. An action may include invoking an application or an application function. An action may include changing a state of a user interface. An action may include inputting text in an application. An action may include manipulating an item in a user interface. An action may include converting text to speech and outputting the speech to a speaker. If the user's intent cannot be determined from the entry, an action may include a raw user interface action associated with the data stored in the entry.

If a user interface associated with the system state described by the system state data has changed since the recording of the command, contextual information from the user interface and contextual data associated with the system state data may be processed to determine the action. Contextual information, such as descriptions of items in the user interface, may be extracted from the user interface. The contextual information for the items may be compared to the contextual data to identify the item in the user interface that is to be manipulated during play back of the voice command.

Once the action is determined, the action is performed by the client device (910). Performing the action may include, for example, invoking a system operation, invoking an application or an application function, changing a state of a user interface, inputting text into an application, manipulating an item in a user interface, or converting text to speech and outputting the speech to a speaker.

If the end of the log file has not been reached, the process 900 repeats from 906. The process 900 ends play back of the command when the end of the log file is reached (912).

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A computer-implemented method comprising:
identifying a log associated with a user-defined command, the user-defined command being previously recorded by a user of a computing device, the log including a plurality of entries, the plurality of entries arranged in an order representing an order of the user's interactions with a user interface of the computing device when the user-defined command was being recorded by the user, at least one entry of the plurality of entries including raw user data representing the user's interaction with the user interface and system state data representing a system state of the computing device associated with the raw user data;
determining a current system state of the computing device;
in response to receiving data indicative of a user-initiated playback of the user-defined command:
identifying an entry of the plurality of entries that includes system state data that matches the current system state of the computing device, the identified entry occurring after a first entry in the log,
bypassing performance of one or more actions associated with one or more entries that (i) occur before the identified entry of the plurality of entries that includes system state data that matches the current system state of the computing device, and (ii) include raw user data representing the user's interaction with the user interface and system state data representing the system state of the computing device associated with the raw user data, and
after bypassing performance of the one or more actions associated with the one or more entries that occur before the identified entry of the plurality of entries that (i) includes the system state data that matches the current system state of the computing device, and (ii) includes raw user data representing the user's interaction with the user interface and system state data representing the system state of the computing device associated with the raw user data, performing an action associated with the identified entry of the plurality of entries that includes system state data that matches the current system state of the computing device.

2. (canceled)

3. The method of claim 1, wherein the identified entry includes contextual data representing contextual information from the user interface and the method further comprises:
processing the contextual data representing the contextual information to identify an item in a user interface screen of the user interface; and
performing the action on the identified item.

4. The method of claim 1, wherein the action comprises invoking an application function.

5. The method of claim 1, wherein the action comprises performing a system operation.

6. The method of claim 1, wherein the action comprises changing the current system state of the computing device to a different system state.

7. The method of claim 1, wherein the action comprises:
converting text to speech; and
outputting the speech to a speaker.

8. A non-transitory computer storage medium encoded with a computer program, the program comprising instructions that when executed by one or more computers cause the one or more computers to perform operations comprising:
identifying a log associated with a user-defined command, the user-defined command being previously recorded by a user of a computing device, the log including a plurality of entries, the plurality of entries arranged in an order representing an order of the user's interactions with a user interface of the computing device when the user-defined command was being recorded by the user, at least one entry of the plurality of entries including raw user data representing the user's interactions with the user interface of the computing device and system state data representing a system state of the computing device associated with the raw user data;
determining a current system state of the computing device;
in response to receiving data indicative of a user-initiated playback of the user-defined command:
identifying an entry of the plurality of entries that includes system state data that matches the current system state of the computing device, the identified entry occurring after a first entry in the log,
bypassing performance of one or more actions associated with one or more entries that (i) occur before the identified entry of the plurality of entries that includes system state data that matches the current system state of the computing device, and (ii) include raw user data representing the user's interaction with the user interface and system state data representing the system state of the computing device associated with the raw user data, and
after bypassing performance of the one or more actions associated with the one or more entries that occur before the identified entry of the plurality of entries that (i) includes the system state data that matches the current system state of the computing device, and (ii) includes raw user data representing the user's interaction with the user interface and system state data representing the system state of the computing device associated with the raw user data, performing an action associated with the identified entry of the plurality of entries that includes system state data that matches the current system state of the computing device.

9. The non-transitory computer storage medium of claim 8, wherein the entry includes data representing contextual information from the user interface and the instructions that when executed by one or more computers cause the one or more computers to perform operations further comprising:
processing the data representing the contextual information to identify an item in the user interface screen; and
performing the action on the identified item.

10. (canceled)

11. The non-transitory computer storage medium of claim 9, wherein the action comprises selecting the identified item.

12. The non-transitory computer storage medium of claim 9, wherein the action comprises entering text into the identified item.

13. The non-transitory computer storage medium of claim 9, wherein the action comprises changing an attribute of the identified item.

14. The non-transitory computer storage medium of claim 9, wherein the action comprises:
converting text associated with the identified item to speech; and
outputting the speech to a speaker.

15. A system comprising:
one or more computers; and
a computer-readable medium coupled to the one or more computers having instructions stored thereon which, when executed by the one or more computers, cause the one or more computers to perform operations comprising:
identifying a log associated with a user-defined command, the user-defined command being previously recorded by a user of a computing device, the log including a plurality of entries, the plurality of entries arranged in an order representing an order of the user's interactions with a user interface of the computing device when the user-defined command was being recorded by the user, at least one entry of the plurality of entries including raw user data representing the user's interactions with the user interface of the computing device and system state data representing a system state of the computing device associated with the raw user data;
determining a current system state of the computing device;
in response to receiving data indicative of a user-initiated playback of the user-defined command:
identifying an entry of the plurality of entries that includes system state data that matches the current system state of the computing device, the identified entry occurring after a first entry in the log,
bypassing performance of one or more actions associated with one or more entries that (i) occur before the identified entry of the plurality of entries that includes system state data that matches the current state of the computing device, and (ii) include raw user data representing the user's interaction with the user interface and system state data representing the system state of the computing device associated with the raw user data, and
after bypassing performance of the one or more actions associated with the one or more entries that occur before the identified entry of the plurality of entries that (i) includes the system state data that matches the current system state of the computing device, and (ii) includes raw user data representing the user's interactions with the user interface and system state data representing the system state of the computing device associated with the raw user data, performing an action associated with the identified entry of the plurality of entries that includes the system state data that matches the current system state of the computing device.

16. (canceled)

17. The system of claim 15, wherein the entry includes contextual data representing contextual information from the user interface and the instructions that when executed by the one or more computers cause the one or more computers to perform operations further comprising
processing the contextual data representing the contextual information to identify an item in the user interface screen; and
performing the action on the identified item.

18. The system of claim 15, wherein the action comprises invoking an application function.

19. The system of claim 15, wherein the action comprises performing a system operation.

20. The system of claim 15, wherein the action comprises changing a system state of the computing device.

21. The system of claim 15, wherein the action comprises:
converting text to speech; and
outputting the speech to a speaker.

22. The computer-implemented method of claim 1, wherein the current system state includes an application that is running in a foreground of the computing device and a user interface screen that is being displayed by the computing device.

23. The non-transitory computer storage medium of claim 8, wherein the current system state includes an application that is running in a foreground of the computing device and a user interface screen that is being displayed by the computing device.

24. The system of claim 15, wherein the current system state includes an application that is running in a foreground of the computing device and a user interface screen that is being displayed by the computing device.
